(19) United States
(12) Patent Application Publication
(10) Pub. No.: US 2009/0061671 A1
(43) Pub. Date: Mar. 5, 2009

(54) ELECTRICAL CONNECTOR WITH A PAIR OF IMPROVED DETACTING PINS

(75) Inventors: Fa-Xiang Qin, Kunshan (CN); Zhen-Sheng Wang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 12/231,497

(22) Filed: Sep. 2, 2008

(30) Foreign Application Priority Data
Sep. 3, 2007 (CN) 200720046919.X

(51) Int. Cl. H01R 29/00

(52) U.S. Cl. 439/188

(57) ABSTRACT

An electrical connector includes an insulating housing defining a base portion and a tongue portion extending forwards from a front face of the base portion, a plurality of terminals and a pair of detecting pins having a moveable pin and an immoveable pin. Each terminal defines a contacting portion located on the bottom face of the tongue portion and a solder leg extending towards a bottom face of the base portion. The two pins respectively define a contacting section spaced from and mating with each other and a leg section spaced from each other. The moveable pin defines an arc section projecting forwards beyond the front face of the tongue portion.

### BACKGROUND OF THE INVENTION

1. Field of the invention

The present invention relates to an electrical connector having a pair of detecting pins.

2. Description of Related Art

U.S. Pat. No. 5,674,085 discloses an electrical connector having a insulating housing defining a tongue portion, a shielding shell surrounding the housing and conductive terminals located on the tongue portion and a detecting pin. The detecting pin is retained in the housing and has a cantilever portion bent and extending below the tongue portion. The cantilever portion will engage with one conductive terminal when a mating connector is inserted into the connector to complete a detecting function.

However, electrical reliability of the terminals will face challenge since one of the terminal functions as a detecting pin synchronously. The cantilever is longer so that it might be permanently distorted.

Therefore, an electrical connector with improved detecting pins is desired to overcome the disadvantages of the related arts.

### SUMMARY OF THE INVENTION

An object of the present invention is to provide an electrical connector with a pair of improved detecting pins.

In order to achieve above-mentioned object, an electrical connector includes an insulating housing defining a base portion and a tongue portion extending forwards from a front face of the base portion, a plurality of terminals and a pair of detecting pins having a moveable pin and an immoveable pin. Each terminal defines a contacting portion located on the bottom face of the tongue portion and a solder leg extending towards a bottom face of the base portion. The two pins respectively define a contacting section spaced from and mating with each other and a leg section spaced from each other. The moveable pin defines an arc section projecting forwards beyond the front face of the tongue portion.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a top and rear perspective view of an electrical connector of a first embodiment;

FIG. 2 is a bottom and front perspective view of the electrical connector shown in FIG. 1;

FIG. 3 is a perspective view of part of the electrical connector shown in FIG. 2;

FIG. 4 is an exploded perspective view of the connector shown in FIG. 1;

FIG. 5 is an exploded perspective view of the connector shown in FIG. 2;

FIG. 6 is a partially cut-out perspective view of the electrical connector; and

FIG. 7 is a partially cut-out perspective view of an electrical connector of a second embodiment.

### DETAILED DESCRIPTION OF THE INVENTION

Reference will now be made to the drawing figures to describe a preferred embodiment of the present invention in detail.

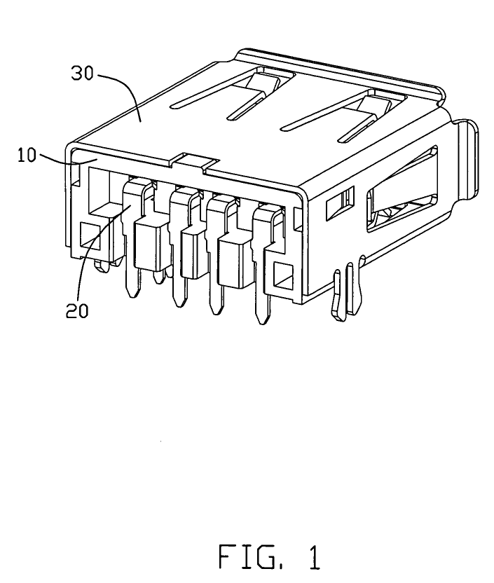

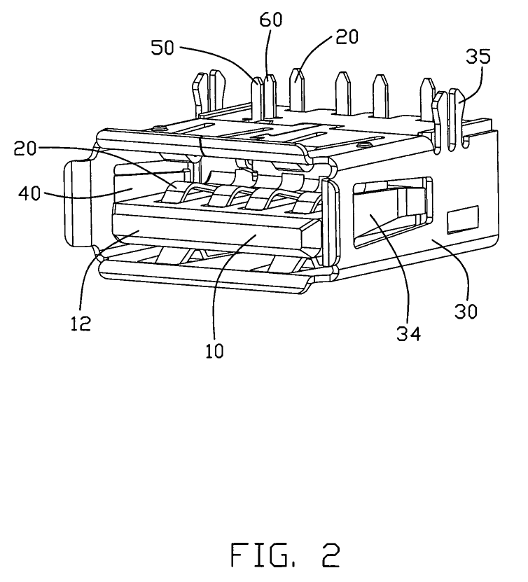

Referring to FIGS. 1 and 2, an electrical connector 1 of a first embodiment of the present invention is used to mate with a counter connector and comprises an insulating housing 10, a plurality of terminals 20 and a shielding shell 30.

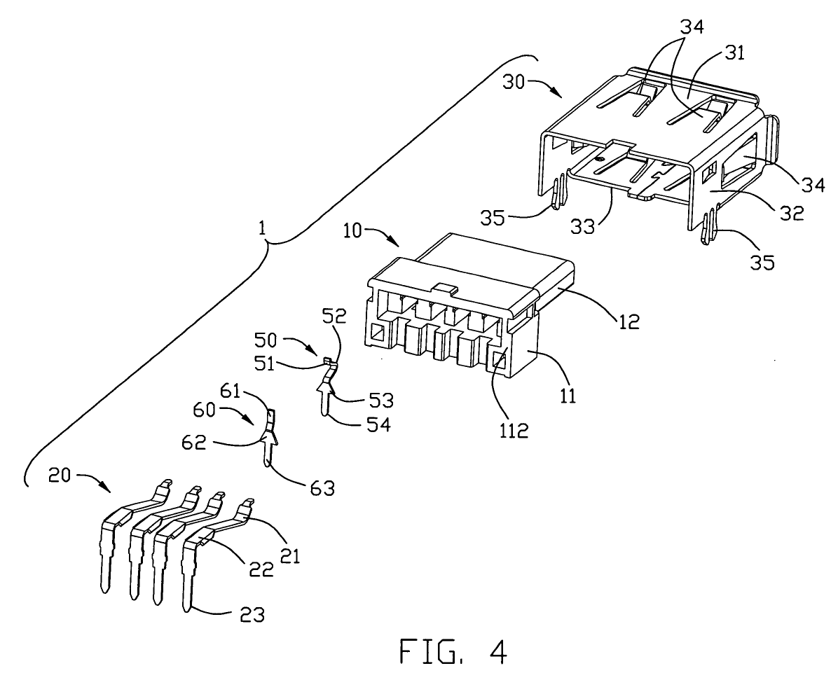

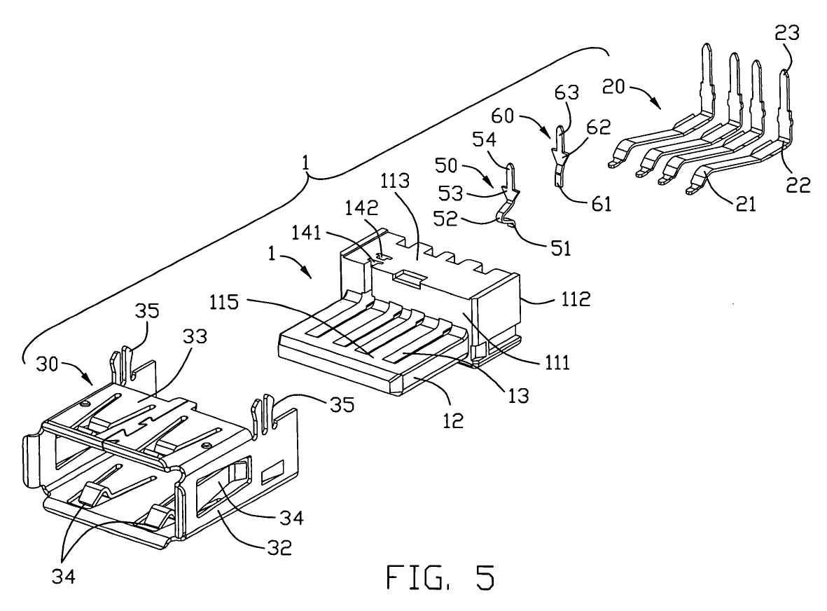

Referring to FIGS. 4 and 5, the insulating housing 10 made from resin material comprises a base portion 11 and a tongue portion 12 extending forward from a front face 111 of the base portion. The bottom surface 115 of the tongue portion 12 defines four parallel passageways 13 which extend backward through the rear surface 112 of the base portion 11. A bottom surface 113, which functions as a connecting face to the PCB, has two holes 141, 142 arranged along a mating direction of the connector and the two holes communicate with the passageway 13. The front hole 141 communicates with the front face 111 of the base portion. The terminals are received in the passageways 13 and each terminal comprises a retaining section 22, a contacting section 21 extending forward from a front end of the retaining section and located in the tongue portion, and a solder leg 23 bend downward from a rear end of the retaining portion.

Referring to FIGS. 4 and 5, the shell 30 made of metal sheet includes top wall 31, sidewalls 32 bend downward from the top wall and a bottom wall 33 which has a pair of wing portions bend inward from the sidewalls. The top wall, sidewalls and bottom wall respectively define inward spring portions 34. A fork retaining leg 35 extends downward from the bottom of each sidewall 32. The shell surrounds and is retained on the base portion 11 and spaced surrounds the tongue portion to define a mating space 40 as best shown in FIG. 2 to be mated with the counter connector.

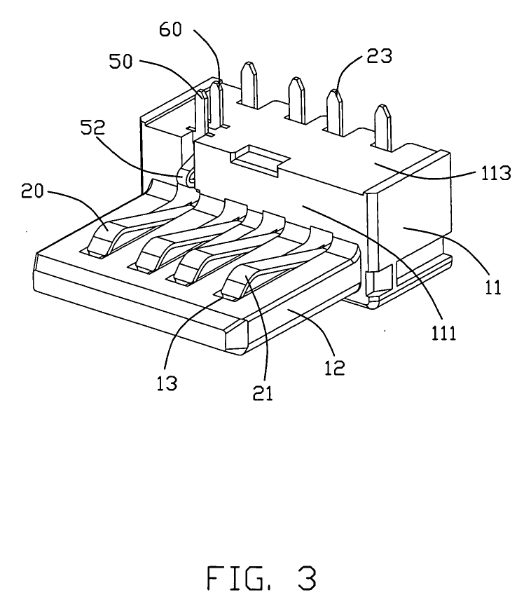

The connector 1 further comprises a pair of detecting pins 50, 60 retained in the holes 141,142 of the housing 1. The first detecting pin 50 is a moveable pin and comprises a retaining section 53, a leg portion 54 extending downward from a bottom end of the retaining section and an arc section 52 bend from top end of the retaining section 53. The second detecting pin 60 is an immoveable pin and comprises a retaining section 62, a leg portion 63 extending downward from a bottom end of the retaining section 62 and a contacting section 61 extending upright from a top end of the retaining section 62. As shown in FIG. 3, the first detecting pin 50 is received in the first hole 141 and the second pin 60 is received in the second hole 142. The arc section 52 of the first detecting pin 50 projects beyond the front face 111 of the base portion. The leg sections of the two pins extend downward beyond the connecting face 113.

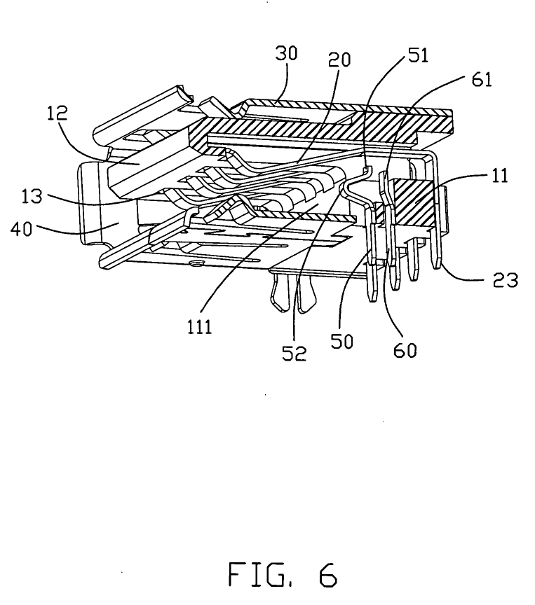

As shown in FIG. 6, the terminals 20 partly project downward into mating space 40. The first detecting pin 50 is in front of the second pin 60 and the arc section 52 projects into the mating space 40. When the mating space is inserted by the counter connector, the front end of the counter connector will press on the arc section 52 to move the arc section backward, i.e. in the mating direction, and urges the contacting section 51 of the first detecting pin to touch the contact section 61 of the second pin. As a result the two detecting pins complete detecting function.

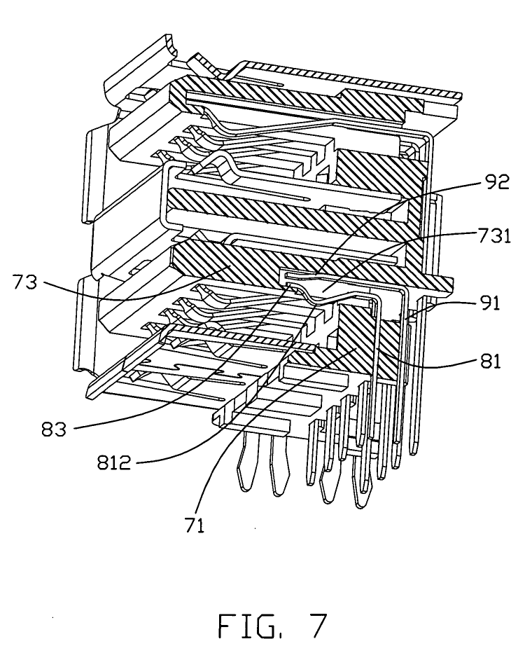

An another embodiment is provided in FIG. 7. The electrical connector 7 is a stacked connector which is provided for insertion of two counter connectors. The lower tongue portion 73 has a groove 731 on the bottom face thereof and the groove 731 opens downward and runs though the rear wall of the insulating housing. Two detecting pins are similar to the two pin of said first embodiment. The retaining portion 81, 91 are retained the base portion of the housing 71 in the upper-lower direction. The arc section 82 of the first detecting pin perpendicularly bend forward to receive in the groove 731 and the contacting section of the second detecting pin perpendicularly bend forward to be received in the groove 731. The arc section 82 of the first detecting pin projects downwards in into the mating space, i.e. in a vertical direction perpendicular to the mating direction. The second detecting pin is located above the first detecting pin. When the mating space is inserted by the counter connector, the front end of the counter connector will press on the arc section 82 to move the arc section upward and urges the contacting section 83 of the first detecting pin to touch the contact section 92 of the second pin. As a result the two detecting pins complete detecting function.

However, the disclosure is illustrative only, changes may be made in detail, especially in matter of shape, size, and arrangement of parts within the principles of the invention.

What is claimed is:

1. An electrical connector comprising:
an insulating housing defining a base portion and a tongue portion extending forwards from a front face of the base portion;
a plurality of terminals, each defining a contacting portion located on the bottom face of the tongue portion and a solder leg extending towards a bottom face of the base portion;
a pair of detecting pins comprising a moveable pin and an immoveable pin, the two pins respectively defining a contacting section spaced from and mating with each other and a leg section spaced from each other;
wherein the moveable pin defines an arc section projecting forwards beyond the front face of the base portion.

2. The electrical connector as described in claim 1, wherein base portion defines a first and a second holes therein, the first hole runs through the front face to receive the moveable pin and allow the arc section to pass, the second pin is behind the first hole to receive the immoveable pin.

3. The electrical connector as described in claim 2, wherein the moveable pin comprises a retaining section retained in the first hole, the solder leg extends downward from one lower end of the retaining section, the arc section bends forward from an upper end of the retaining section, the contact section is at a top end of the arc portion.

4. The electrical connector as described in claim 3, wherein the immoveable pin comprises a retaining section retained in the second hole, the solder leg extends downward from one lower end of the retaining section, the contacting section extends upward from an upper end of the retaining section.

5. The electrical connector as described in claim 1, further comprising a shield shell surrounding the insulating housing and a mating space being defined between the bottom surface of the tongue portion and the shell.

6. An electrical connector comprising:
an insulating housing defining a base portion and a tongue portion extending forwards from a front face of the base portion;
the bottom face of the tongue portion defining a groove and the base portion defines a first and a second holes communicate with the groove;
a plurality of terminals, each defining a contacting portion located on the bottom face of the tongue portion and a solder leg extending towards a bottom face of the base portion;
a pair of detecting pins comprising a moveable pin and an immoveable pin, the two pin respectively defining a retaining section retained in the holes;
the immoveable pin defining an arc portion bend perpendicular from an upper end of the retaining section, a contact section at a front end of the arc section and a solder leg extending downwards from a lower end of the retaining section, the arc section projecting downward beyond the bottom surface of the tongue portion.

7. The electrical connector as described in claim 6, wherein the arc section and the contacting section are aligned with each other in an upper to lower direction.

8. An electrical connector comprising:
an insulative housing defining a base portion with a tongue portion extending forwardly from a front face of the base portion;
a metallic shell assembled to the housing and defining a mating port for receiving an inserted plug, into which said tongue portion extends;
said mating port and said tongue portion dimensioned and configured to be essentially of a standard USB (Universal Serial Bus) mating interface;
a plurality of contacts disposed in the housing with corresponding deflectable contacting sections exposed into the mating port in compliance with the standard USB mating interface;
first and second switch terminals disposed in the housing and both having the soldering section independently mounted to a printed circuit board, the first switch terminal defining a movable contacting section extending into the mating port for engagement with said inserted plug, said first switch terminal and said second switch terminal being disengaged from each other when said contacting section freely extends into the mating port while engaged with each other when said contacting section is pressed by the inserted plug; wherein said first switch terminal is not mechanically and electrically engaged with any of said contacts disregarding whether said contacting section is pressed by the inserted plug or not.

9. The electrical connector as claimed in claim 8, wherein said first and second switch terminals are aligned with not only each other but also one of said contacts in an insertion direction of said inserted plug.

10. The electrical connector as claimed in claim 9, wherein said contacting section forwardly extends into the mating port.

11. The electrical connector as claimed in claim 9, wherein said first and second switch terminals are vertically assembled into the housing.

12. The electrical connector as claimed in claim 8, wherein said first and second switch terminals are aligned with each other in an insertion direction of the inserted plug while not aligned with any of said contacts in said insertion direction.

13. The electrical connector as claimed in claim 12, wherein said contacting section vertically extends into the mating port.

14. The electrical connector as claimed in claim 12, wherein the first and second switch terminals are forwardly assembled into the housing.

15. The electrical connector as claimed in claim 8, wherein a width of the contact is essentially 1 mm as a regular type.

16. The electrical connector as claimed in claim 8, wherein said second switch terminal is stationary.
